(19) United States
(12) Patent Application Publication
(10) Pub. No.: US 2006/0249602 A1
(43) Pub. Date: Nov. 9, 2006

(54) Manifold spray gun seal

(75) Inventor: Nigel P. Wright, Marion, IA (US)

Correspondence Address: MCKEE, VOORHEES & SEASE, P.L.C., 801 GRAND AVENUE, SUITE 3200, DES MOINES, IA, 50309-2721, US

(73) Assignee: VECTOR CORPORATION, Marion, IA (US)

(21) Appl. No.: 11/109,919

(22) Filed: Apr. 20, 2005

(51) Int. Cl. B05B 1/00

(52) U.S. Cl. 239/600; 239/589; 239/DIG. 4

(57) ABSTRACT

The current invention is a seal for use in a manifold spray gun system comprising an elastomer disk having a film body with opposite first and second sides. The disk is configured with one or more openings extending through the disk from the first side to the second side and with raised surfaces around the openings. The disk also has a perimeter bead on both sides.

### BACKGROUND OF THE INVENTION

The current invention relates to seals for spray equipment. Specifically, the current invention relates to a one piece seal for a manifold spray gun assembly.

The coating industry uses various arrangements of tubing to supply solutions or materials and pressurized air to spray gun assemblies to apply a coating to a wide range of items, such as seeds, pharmaceuticals, cereals and snack food. In an effort to make cleanup of the equipment easier, the general approach has been to incorporate the tubing which supplies the different solutions or materials and air to the spray gun assemblies into a manifold system designed with multi-ported manifolds connecting several spray gun assemblies together.

A major problem with this type of manifold system is how to create a seal between each of the spray gun assembly and the manifolds. The seal of the joint between the spray gun assemblies and the manifolds is typically done with multiple O-rings, which are difficult to remove without damage, difficult to clean, difficult to reassemble, and easy to misplace.

One solution to this type of problem is shown in U.S. Pat. No. 5,342,097 to Hanson. As seen in Hanson, FIGS. 3 and 9, a gasket 37 carries crush ribs 63 which provide a fluid type seal around passages 41, 42, 43 at the interface of surfaces 44 with the gasket 37. One problem with the gasket of the Hanson patent is that if one or more of the crush ribs 63 fail, the fluid is likely to leak outside of the manifold/spray gun assembly connection.

Thus, it is desirable to have a single seal which will replace the traditional O-ring seals and is easy to remove, clean and replace. In addition, it is also desirable for a seal which provides a secondary line of protection against leakage.

The primary objective of the current invention is an improved manifold spray gun seal.

A further objective of the present invention is to provide a single-piece modular gasket for connecting manifold spray gun assemblies to manifolds.

A further objective of the present invention is to provide a spray gun assembly system in which multiple manifold spray guns are connected together with multiple manifolds using a single-piece modular seal there between.

A further objective of the present invention is a provision of a manifold spray gun seal which is economical to manufacture, durable in use, and efficient in operation.

One or more of these or objects of the invention will be apparent from the specification and claims that follow.

### SUMMARY OF THE INVENTION

The foregoing objects may be achieved by a seal for use in a manifold spray gun system comprising an elastomer formed as an annular disk with a first side and a second side. The disk is configured with two or more openings extending through the disk from the first side to the second side and formed with raised surfaces around the openings.

A further feature of the present invention involves a seal configured with raised surfaces on both a first side and a second side.

A further feature of the present invention involves a seal configured with two or more openings extending through the seal from the first side to the second side with raised surfaces around the openings and an additional raised surface around more than one of the openings.

A further feature of the present invention involves a seal to prevent leakage from the connection between a manifold assembly and a spray gun assembly.

A further feature of the present invention involves a seal which is made from silicone.

The foregoing objects may also be achieved by a manifold spray device comprising one or more manifold assemblies, with each manifold assembly being configured as an elongated member with one or more fluid passageways extending through the assembly from a first end to a second end so that fluid can flow through the passageways. One or more spray gun assemblies are configured so that the fluid passageways in each of the spray gun assemblies align with the fluid passageways in the corresponding manifold assemblies. Each manifold assembly is operatively connected to the spray gun assembly with a seal there between. The seal is an elastomer formed as an annular disk with a first side and a second side, and with one or more openings extending through the disk from the first side to the second side so that fluid can flow from the manifold assembly to the spray gun assembly through the fluid passageways. The seal openings are formed with raised perimeter edges to prevent leakage of fluid from the fluid passageways between the manifold assembly and the spray gun assembly.

A further feature of the present invention involves a spray device wherein a seal is configured with an annular ring raised relative to the disk around openings in the seal to form a second seal to further prevent leakage of fluid.

A further feature of the present invention involves a spray device wherein a seal is configured to eliminate the use of multiple O-rings between a manifold assembly and a spray gun assembly.

A further feature of the present invention involves a spray device wherein a seal is made from silicone.

### BRIEF DESCRIPTION OF THE DRAWINGS

FIG. 1 shows a plan view of one embodiment of a manifold spray gun seal.

FIG. 2 shows a sectional view of the seal taken along lines 2-2 of FIG. 1.

FIG. 3 is an exploded view of one embodiment of a manifold spray gun assembly using the seal of the current invention.

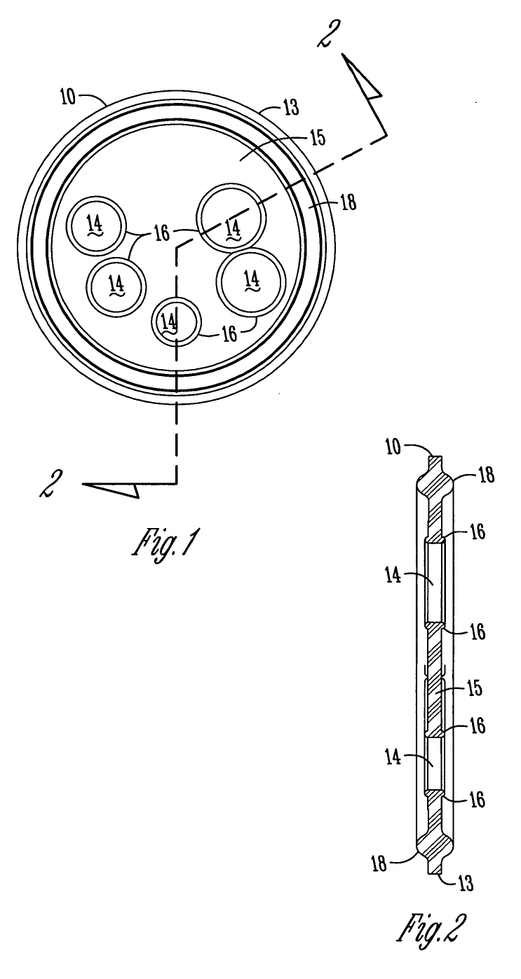

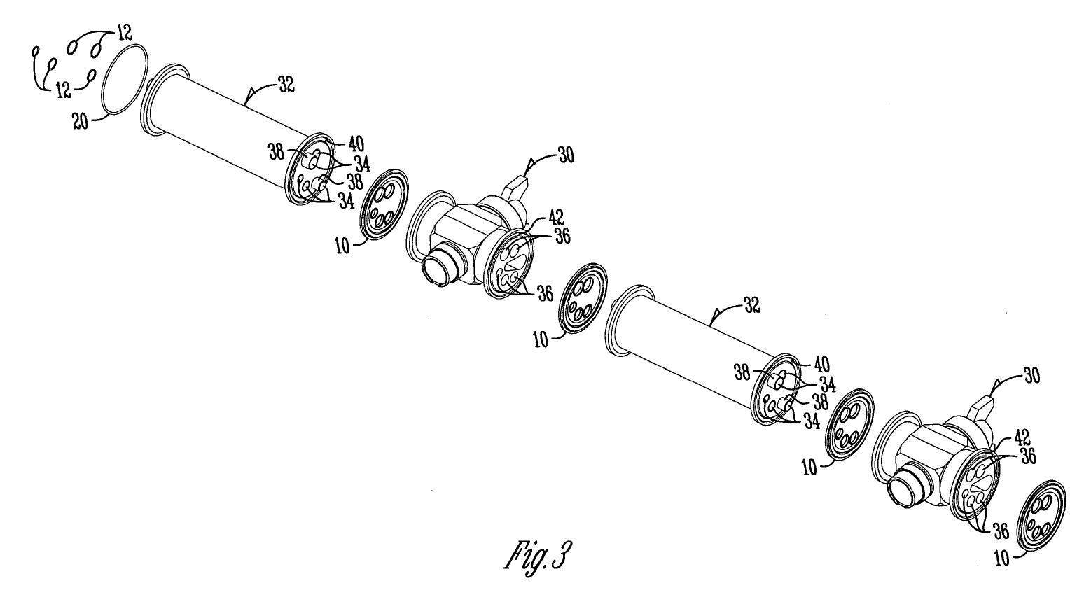

### DETAILED DESCRIPTION OF THE PREFERRED EMBODIMENT

This invention is directed to an improved seal or gasket 10 designed to replace the cumbersome, yet traditional O-rings 12 and a traditional sanitary gasket 20, as seen in FIG. 3, to seal fluid passageways 34 from leaking fluids between the passageways 34 at the junctions of the manifold assemblies 32 and the spray gun assemblies 30.

The manifold gasket 10 is dimensionally similar to a standard sanitary gasket 20 except that instead of having one large hole or opening through the center, it is formed as a solid disk having a perimeter edge 13, an internal film body 15, and multiple smaller openings 14. The openings 14 are arranged to align with the openings or fluid passageways 34 in the manifold assemblies 32 and the spray gun assemblies 30. Each of the openings 14 in the seal 10 have a raised protrusion or integral O-ring seal 16 around the opening 14. The manifold gasket 10 is made from the same material throughout the entire gasket 10.

The manifold gasket 10 is also preferred to have a raised protrusion or S-type gasket bead 18, which goes around all of the openings 14.

The manifold gasket 10 may be made from any suitable elastomer. However, silicone is the preferred elastomer. Silicone is flexible enough to create an excellent seal, withstands the high temperatures used in coating processes, and is generally accepted in the pharmaceutical industry.

The embodiment of the manifold gasket 10 shown contains five openings 14. However any number of openings 14 may be used with this invention. The number of openings 14 required depends upon how many fluids such as a spray solution, the user is sending through the manifold spacer assembly 32 to the spray gun assemblies 30.

The shape of the integral O-ring seal 16 is shown to be a circular shape which follows a circular opening 14 in the gasket 10. However, any shape opening 14 and integral O-ring seal 16 may work with this invention. Similarly, the integral O-ring seal 16 does not need to be in the same shape as the opening 14. Furthermore, the S-type gasket bead 18 shown is a circular raised protrusion around the outside edge of the manifold gasket 10. Again, any shape of S-type gasket bead 18 can be used with this invention. Plus, the S-type gasket bead 18 does not need to follow along the outside edge of the gasket 10 or in the same shape as the outside edge of the manifold gasket 10.

FIG. 3 shows an exploded view of a manifold style spray gun assembly. This particular assembly includes two spray gun assemblies 30 and two manifold assemblies 32. Other length, quantities, and configurations of manifold assemblies 32, as well as other styles and quantities of spray gun assemblies 30 may be used with this invention. The manifolds 32 have fluid passages 34 which align with fluid passage 36 in the gun assemblies 30. One or more of the passages 34 may include an extension or nipple 38 for locating or positioning the manifold gasket 10, as seen in FIG. 3. However, protrusions 38 are not necessary. As an alternative or in addition to the protrusions 38, the manifold 32 and gun assembly 30 may have an annular groove 40, 42 at each end to matingly receive the gasket bead 18. Once the manifold gasket 10 is installed on the manifold assembly fluid passageways 34, then the manifold assembly 32 can be mated with the spray gun assembly 30 and clamped together using a conventional sanitary clamp. The sanitary clamp is not shown.

The current invention can be used with any different type of spray gun and manifold type system using any different type of coating material. The gasket 10 should be constructed from a material which will not be adversely affected by the fluid being used for coating.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A seal for use in a manifold spray gun system comprising:
an elastomer disk with a first side and a second side;
two or more openings extending through the disk from the first side to the second side; and
raised surfaces extending around each of the disk openings.

2. The seal of claim 1 wherein with the raised surfaces reside on both the first side and the second side of the disk.

3. The seal of claim 1 further comprising a raised bead adjacent the perimeter of the disk.

4. The seal of claim 3 wherein the bead is formed on both the first and the second sides of the disk.

5. The seal of claim 3 wherein the disk, raised surfaces, and bead have a one-piece construction.

6. The seal of claim 1 wherein the disk is made from silicone.

7. A manifold spray device comprising:
a manifold assembly;
the manifold assembly configured as an elongated member with a fluid passageway extending through the assembly from a first end to a second end so that fluid can flow through the passageway;
a spray gun assembly;
the spray gun assembly having a fluid passageway aligned with the fluid passageway in the manifold assembly;
the manifold assembly operatively connected to the spray gun assembly;
a seal between the manifold and spray gun assemblies, and having a perimeter edge, a film body within the perimeter edge, and;
an opening extending through the body, the openings being aligned with the fluid passageways of the manifold and spray gun assemblies so that fluid can flow from the manifold assembly to the spray gun assembly through the fluid passageways; and
the seal having a raised surface extending around the opening to prevent leakage of material from the material passageways between the manifold assembly and the spray gun assembly.

8. The spray device of claim 7 wherein the seal includes a perimeter bead adjacent the perimeter edge to further prevent leakage of material.

9. The spray device of claim 7 wherein the seal is made from silicone.

10. The spray device of claim 7 wherein the seal has a one-piece construction.

11. The spray device of claim 7 wherein the raised surface is provided on opposite sides of the body around the opening.
